(19) United States
(12) Patent Application Publication
(10) Pub. No.: US 2013/0279383 A1
(43) Pub. Date: Oct. 24, 2013

(54) Method of Managing Discontinuous Reception Functionality

(71) Applicant: ACER INCORPORATED, New Taipei City (TW)

(72) Inventor: Shiang-Rung Ye, New Taipei City (TW)

(73) Assignee: ACER INCORPORATED, New Taipei City (TW)

(21) Appl. No.: 13/769,390

(22) Filed: Feb. 18, 2013

Related U.S. Application Data
(60) Provisional application No. 61/635,868, filed on Apr. 20, 2012.

(30) Foreign Application Priority Data
Jan. 15, 2013 (TW) 102101519

(51) Int. Cl. H04W 52/02

(52) U.S. Cl. CPC H04W 52/02
USPC 370/311

(57) ABSTRACT

A method of managing discontinuous reception (DRX) functionality for a network of a wireless communication system includes receiving information associated to a setting change from a mobile device of the wireless communication system, and configuring the DRX functionality for the mobile device according to the information.

### CROSS REFERENCE TO RELATED APPLICATIONS

This application claims the benefit of U.S. Provisional Application No. 61/635,868, filed on Apr. 20, 2012 and entitled “Timing Reference Reporting and power saving”, the contents of which are incorporated herein.

### BACKGROUND OF THE INVENTION

1. Field of the Invention

The application relates to a method utilized in a wireless communication system, and more particularly, to a method of managing discontinuous reception functionality in a wireless communication system.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

In the LTE system, the UE may be configured with a DRX (Discontinuous Reception) functionality, which allows the UE to monitor a signaling transmission of a PDCCH (Physical Downlink Control Channel) during a specific period of time, so as to reduce a power consumption of the UE. Noticeably, the DRX functionality shall be configured by the eNB and a setting may include a short DRX cycle and a long DRX cycle. In detail, a DRX cycle may include a waking period and a sleeping period. If the UE receives a packet during the waking period, the waking period shall be extended, which allows the UE to wait for possible incoming packets. In other words, the eNB tends to configure the DRX cycle having a longer waking period to the UE so that the UE may received the possible incoming packets.

Applicant notices a problem that if the UE is configured with a longer waking period, it can deliver received IP (Internet Protocol) packets to applications without much delay to provide good user experience, but the configuration of the DRX functionality may lead to bad power consumption to the UE. On the contrary, if the UE is configured with a longer sleeping period, it can save more power but may delay real-time packets. However, currently, the LTE system specification does not specify how the eNB shall select proper lengths for waking/sleeping periods to configure the DRX functionality for the UE, which brings the abovementioned problem.

### SUMMARY OF THE INVENTION

The application discloses a method of managing discontinuous reception functionality in a wireless communication system in order to solve the abovementioned problem.

A method of managing discontinuous reception (DRX) functionality for a mobile device of a wireless communication system is disclosed. The method comprises transmitting information associated to a setting to a network of the wireless communication system when the setting of the mobile device is changed such that the network configures the DRX functionality for the mobile device according to the information.

A method of managing discontinuous reception (DRX) functionality for a network of a wireless communication system is disclosed. The method comprises receiving information associated to a setting change from a mobile device of the wireless communication system, and configuring the DRX functionality for the mobile device according to the information.

A method of managing discontinuous reception (DRX) functionality for a mobile device of a wireless communication system is disclosed. The method comprises configuring the DRX functionality for the mobile device according to a setting of the mobile device when the setting of the mobile device is changed.

A communication system for managing discontinuous reception (DRX) functionality is disclosed. The method comprises a mobile device for transmitting information associated to a setting of the mobile device when the setting is changed, and a network for configuring a DRX functionality for the mobile device according to the information when the information associated to a setting change of the mobile device is received from the mobile device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an exemplary wireless communication system.

FIG. 2 illustrates a schematic diagram of an exemplary communication device.

FIG. 3-5 illustrate schematic diagrams of managing DRX functionality according to several embodiments.

### DETAILED DESCRIPTION

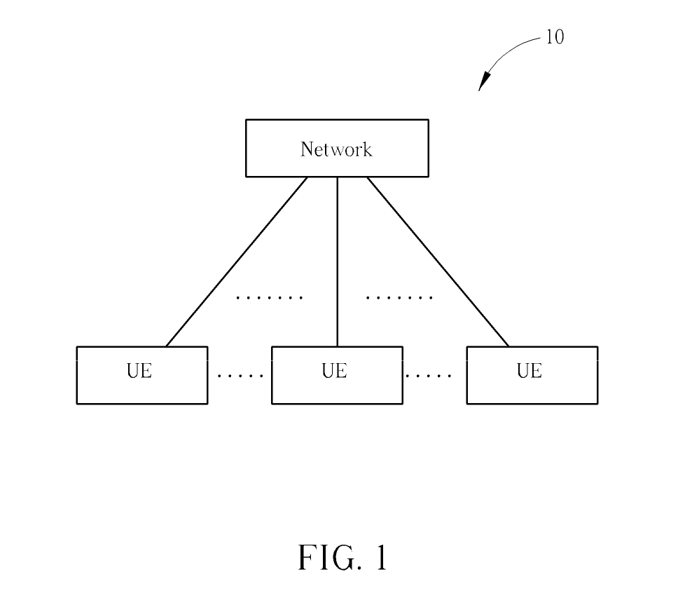

Please refer to FIG. 1, which is a schematic diagram of a wireless communication system 10. The wireless communication system 10 is a Long-Term Evolution (LTE) system or other mobile communication systems, and is briefly composed of a network and a plurality of user equipments (UEs). In FIG. 1, the network and the UEs are simply utilized for illustrating the structure of the wireless communication system 10. Practically, the network may be an evolved universal terrestrial radio access network (E-UTRAN) comprising a plurality of evolved base stations (eNBs). The UEs may be devices such as mobile phones, computer systems, etc. Besides, the network and the UE may be seen as a transmitter or receiver according to transmission direction, e.g., for uplink (UL), the UE is the transmitter and the network is the receiver, and for downlink (DL), the network is the transmitter and the UE is the receiver.

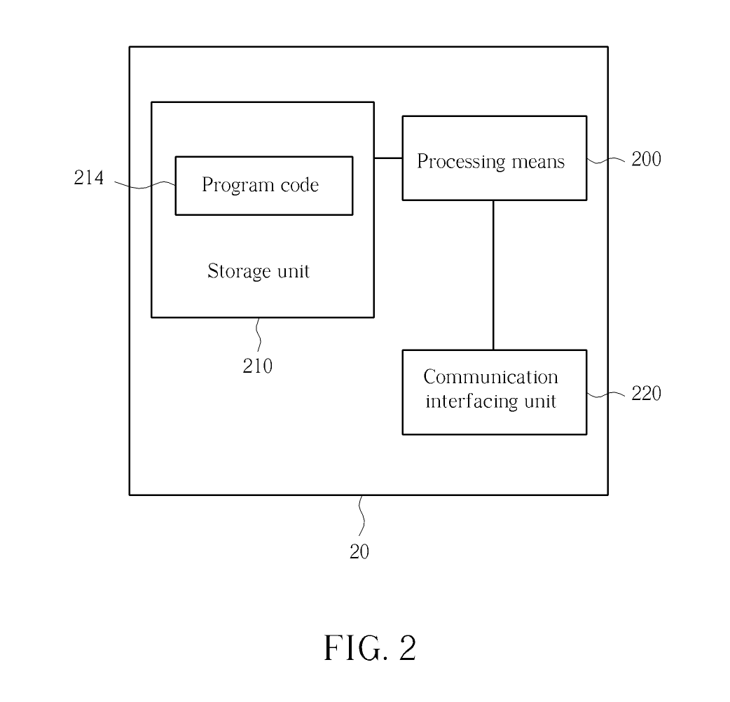

Please refer to FIG. 2, which illustrates a schematic diagram of an exemplary communication device 20. The communication device 20 may be the UE shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that can store program code 214, for access by the processing means 200. Examples of the storage unit 210 include but are not limited to a subscriber identity module (SIM), read-only memory (ROM), flash memory, random-access memory (RAM), CD-ROMs, magnetic tape, hard disk, and optical data storage device. The communication interfacing unit 220 is preferably a radio transceiver and can exchange wireless signals with the network according to processing results of the processing means 200.

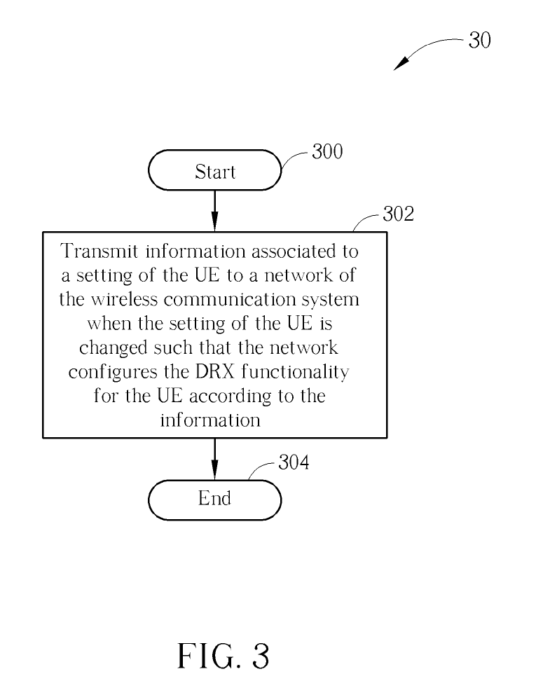

Please refer to FIG. 3, which illustrates a flowchart of an exemplary process 30. The process 30 is utilized in a UE of a wireless communication system for managing DRX functionality to reduce a power consumption of the UE. The process 30 may be compiled into the program code 214 and includes the following steps:

Step 300: Start.

Step 302: Transmit information associated to a setting of the UE to a network of the wireless communication system when the setting of the UE is changed such that the network configures the DRX functionality for the UE according to the information.

Step 304: End.

According to process 30, when the setting of the UE is changed, e.g. an application mode, a power consumption or a required network response time changed by a user, the UE may report information associated to the setting, i.e. the power consumption or the required network response time, to the network, and thus the network, e.g. an eNB, may configure a length of the waking/sleeping period of the DRX functionality for the UE.

For example, the UE may transmit the information of low power consumption to the network when the power consumption of the UE is set to a low power consumption mode by the user. The network may decrease a time of performing reception functionality, i.e. increase the waking period or decrease the sleeping period, after the information is received. Besides, the UE may transmit information of high power consumption to the network when the power consumption of the UE is set to a high power consumption mode. The network may increase the time of performing reception functionality, i.e. increase the waking period or decrease the sleeping period, after the information is received. Therefore, the network may utilize the information associated to the setting change to determine a power parameter, as abovementioned that the network may increase or decrease the sleeping period to change the power parameter, which may effectively save the power consumption of the UE without an influence on the user experience.

In another embodiment, the UE may transmit information associated to a required network response time to the network when the required network response time is decreased. The network may increase a time of performing reception functionality of the DRX functionality, i.e. decrease the sleeping period or increase the waking period, after the information is received. On the contrary, the UE may transmit information associated to a required network response time to the network when the required network response time is increased. The network may decrease a time of performing reception functionality of the DRX functionality, i.e. increase the sleeping period or decrease the waking period, after the information is received. Please note that the user may determine whether to lengthen the network response time to change the power consumption of the UE.

In another embodiment, the user is usually allowed to change an application mode of the UE. The application mode may be a state of activity at present which may further implies the power consumption of the UE to the network. For example, the UE may set with a first application mode for indicating a state of screen on, a second application mode for indicating a state of screen off and sound on, and a third application mode for indicating screen off, sound off and vibration off. Please note that the application mode of the UE is not limited to above examples. For example, the first application mode may be a state of screen on, the second application mode may be a state of screen off, sound off and vibration on, and the third application mode maybe a state of screen off, sound off and vibration off. In detail, the UE may transmit information associated to an application mode change to the network when the UE is change from a first application mode to a second application mode by the user. If a power consumption corresponding to the second application mode is greater than a power consumption corresponding to the first application mode, the network may increase a time of performing reception functionality, i.e. decrease sleeping period or increase waking period. On the contrary, if a power consumption corresponding to the second application mode is less than a power consumption corresponding to the first application mode, the network may decrease a time of performing reception functionality, i.e. increase sleeping period or decrease waking period.

Besides, the present invention may derive the required network response time of the UE according to a setting of the application mode. For example, the UE may set with a first application mode for indicating the user is using a mobile phone such as playing games or watching internet television/video; a second application mode for indicating the user disposes the mobile phone in a pocket/bag and the user would like to know any incoming calls/short messages or application notifications; and a third application mode for indicating the user does not want any sound or vibration to indicate a new call/SMS/app notification from the mobile phone. Therefore, a network response time corresponding to the third application mode shall be greater than a network response time corresponding to the second application mode, and the a network response time corresponding to the second application mode shall be greater than a network response time corresponding to the first application mode. In detail, the UE may transmit information associated to the application mode change to the network when the UE is changed from the first application mode to the second application mode. Please note that if the network response time corresponding to the second application mode is greater than the network response time corresponding to the first application mode, the network may decrease a time of performing reception functionality of DRX functionality, i.e. increase the sleeping period or decrease the waking period, after the information is received. On the contrary, if the network response time corresponding to the second application mode is less than the network response time corresponding to the first application mode, the network may increase the time of performing reception functionality of DRX functionality, i.e. decrease the sleeping period or increase the waking period, after the information is received.

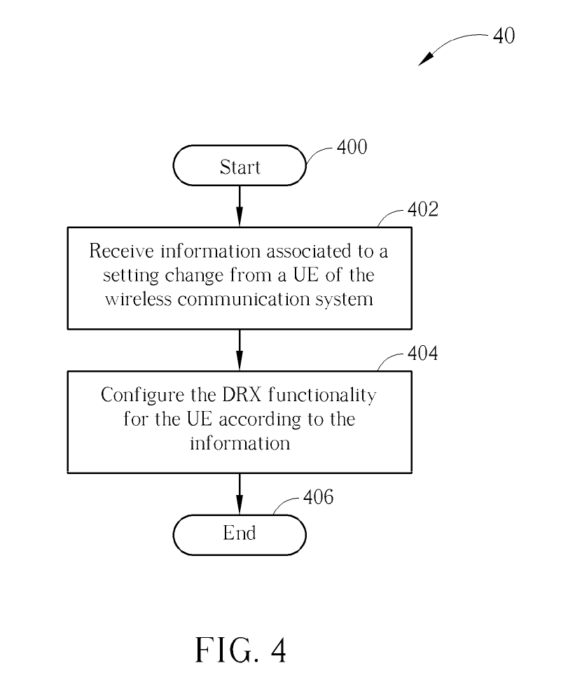

Please refer to FIG. 4, which illustrates a flowchart of an exemplary process 40. The process 40 is utilized in a network of a wireless communication system for managing DRX functionality. The process 40 may be compiled into the program code 214 and includes the following steps:

Step 400: Start.

Step 402: Receive information associated to a setting change from a UE of the wireless communication system.

Step 404: Configure the DRX functionality for the UE according to the information.

Step 406: End.

According to process 40, when the network receives information associated to the setting change such as a power consumption, an application mode or a require network response time from the UE, the network may set lengths of waking/sleeping periods of a DRX cycle according to the information associated to the setting change. Therefore, the network may utilize the information associated to the setting change to determine a power parameter of the UE, which may effectively save power of the UE without an influence to the user experience.

For example, the network may decrease a time of performing reception functionality, i.e. increase the sleeping period or decrease the waking period, when the network receives the information of low power consumption from the UE. On the other hand, the network may increase the time of performing reception functionality, i.e. decrease the sleeping period or increase the waking period, when the network receives the information of high power consumption from the UE. Noticeably, details about the UE transmitting the information associated to the setting change to the network may be obtained by referring to above description, which is omitted herein.

In another embodiment, the network may increase a time of performing reception functionality, i.e. increase the waking period or decrease the sleeping period, when the network receives the information of decreasing network response time from the UE. On the other hand, the network may decrease the time of performing reception functionality, i.e. decrease the waking period or increase the sleeping period, when the network receives the information of increasing the sleeping period from the UE.

In another embodiment, the network may increase a time of performing reception functionality, i.e. increase the waking period or decrease the sleeping period, when the network receives the information of application mode change from the UE, wherein the information indicates the UE is changed from a first application mode to a second application mode and a power consumption corresponding to the second application mode is greater than a power consumption corresponding to the first application mode. On the contrary, the network may decrease a time of performing reception functionality, i.e. decrease the waking period or increasing the sleeping period, when the network receives the information of application mode change from the UE, wherein the power consumption corresponding to the second application mode is less than the power consumption corresponding to the first application mode. Details about the application mode of the UE may be obtained by referring to above description, which is omitted herein.

In another embodiment, the network may decrease a time of performing reception functionality, i.e. decrease the waking period or increasing the sleeping period, when the network receives information of application mode change from the UE, wherein the information indicates the UE is changed from a first application mode to a second application mode and a network response time corresponding to the second application mode is greater than a network response time corresponding to the first application mode. On the contrary, the network may increase a time of performing reception functionality, i.e. increase the waking period or decrease the sleeping period, when the network receives the information of application mode change from the UE, wherein the network response time corresponding to the second application mode is less than the network response time corresponding to the first application mode. Details about the application mode of the UE may be obtained by referring to above description, which is omitted herein.

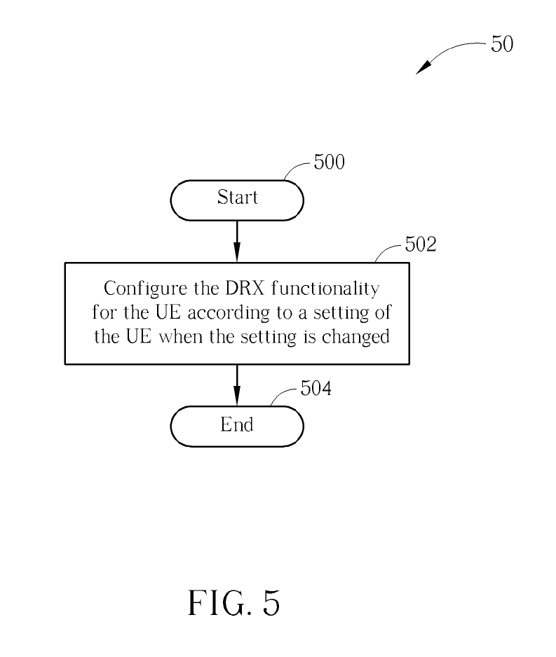

Please refer to FIG. 5, which illustrates a flowchart of an exemplary process 50. The process 50 is utilized in a UE of a wireless communication system for managing DRX functionality to reduce a power consumption of the UE. The process 50 may be compiled into the program code 214 and includes the following steps:

Step 500: Start.

Step 502: Configure the DRX functionality for the UE according to a setting of the UE when the setting is changed.

Step 504: End.

According to process 50, when a setting of the UE is changed, e.g. a power consumption, an application mode or a required network response time changed by a user, the UE may configure lengths of waking/sleeping periods of the DRX functionality for the UE according to a new setting, i.e. the power consumption, the application mode or the required network response time after the change.

For example, the UE may decrease a time of performing reception functionality when the power consumption of the UE is set to a lower power consumption mode, and the UE may increase the time of performing reception functionality when the power consumption of the UE is set to a high power consumption mode. In an embodiment, the UE may increase a time of performing reception functionality when the required network time of the UE is decreased, and the UE may decrease the time of performing reception functionality when the required network time of the UE is increased. In another embodiment, the UE may increase a time of performing reception functionality when the application mode of the UE is changed from a first application mode to a second application mode, and a power consumption corresponding to the second application mode is greater than a power consumption corresponding to the first application mode. On the contrary, the UE may decrease a time of performing reception functionality when the power consumption corresponding to the second application mode is less than the power consumption corresponding to the first application mode. Besides, the application mode may indicate the required network response time of the UE. Thus, the UE may decrease a time of performing reception functionality when the required network response time is increased, and the UE may increase the time of performing reception functionality when the required network response time is decreased. Details of the application mode, e.g. states of screen on/off, sound on/off and vibration on/off, may be obtained by referring to above description, which is omitted herein.

Please note that, the abovementioned steps of the processes including suggested steps may be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, the embodiments of the invention provide methods of managing discontinuous reception (DRX) for the UE and the network by utilizing information associated to setting change of the UE, so as to reduce the power consumption of the UE. Specifically, the UE or the network may derive the setting of the DRX corresponding to an application mode or power consumption by mapping or specific calculations according to the application mode and the power consumption, so as to change the setting for the DRX functionality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing discontinuous reception (DRX) functionality for a mobile device of a wireless communication system, comprising:
transmitting information associated to a setting to a network of the wireless communication system when the setting of the mobile device is changed such that the network configures the DRX functionality for the mobile device according to the information.

2. The method of claim 1, wherein the information indicates an application mode, a power consumption or a required network response time of the mobile device.

3. The method of claim 2, wherein the application mode is a state of activity of the mobile device, the state of activities comprises a screen on/off, a ring-tone volume on/off, and vibration on/off.

4. A method of managing discontinuous reception (DRX) functionality for a network of a wireless communication system, comprising:
receiving information associated to a setting change from a mobile device of the wireless communication system; and
configuring the DRX functionality for the mobile device according to the information.

5. The method of claim 4, wherein the information indicates an application mode, a power consumption or a required network response time of the mobile device.

6. The method of claim 5, wherein the application mode is a state of activity of the mobile device, the state of activities comprises a screen on/off, a ring-tone volume on/off, and vibration on/off.

7. The method of claim 5, wherein the step of configuring the DRX functionality for the mobile device according to the information comprises:
decreasing a time of performing reception functionality of the DRX functionality when the information indicates the mobile device is set to a low power consumption mode; and
increasing the time of performing reception functionality of the DRX functionality when the information indicates the mobile device is set to a high power consumption mode.

8. The method of claim 5, wherein the step of configuring the DRX functionality for the mobile device according to the information comprises:
increasing a time of performing reception functionality of the DRX functionality when the information indicates the required network response time of the mobile device is decreased; and
decreasing the time of performing reception functionality of the DRX functionality when the information indicates the required network response time of the mobile device is increased.

9. The method of claim 5, wherein the step of configuring the DRX functionality for the mobile device according to the information comprises:
increasing a time of performing reception functionality of the DRX functionality when the information indicates the mobile device is set from a first application mode to a second application mode, and a power consumption corresponding to the second application mode is greater than a power consumption corresponding to the first application mode; and
decreasing the time of performing reception functionality of the DRX functionality when the information indicates the mobile device is set from a first application mode to a second application mode, and a power consumption corresponding to the second application mode is less than a power consumption corresponding to the first application mode.

10. The method of claim 5, wherein the step of configuring the DRX functionality for the mobile device according to the information comprises:
decreasing a time of performing reception functionality of the DRX functionality when the information indicates the mobile device is set from a first application mode to a second application mode, and a network response time corresponding to the second application mode is greater than a network response time corresponding to the first application mode; and
increasing the time of performing reception functionality of the DRX functionality when the information indicates the mobile device is set from a first application mode to a second application mode, and a network response time corresponding to the second application mode is less than a network response time corresponding to the first application mode.

11. The method of claim 4, wherein the step of configuring the DRX functionality for the mobile device according to the information comprises:
by mapping or calculation to derive the setting of the DRX functionality according to the information; and
configuring the DRX functionality of the mobile device according to the derived setting of the DRX functionality.

12. A method of managing discontinuous reception (DRX) functionality for a mobile device of a wireless communication system, comprising:
configuring the DRX functionality for the mobile device according to a setting of the mobile device when the setting of the mobile device is changed.

13. The method of claim 12, wherein the information indicates an application mode, a power consumption or a required network response time of the mobile device.

14. The method of claim 13, wherein the application mode is a state of activity of the mobile device, the state of activities comprises a screen on/off, a ring-tone volume on/off, and vibration on/off.

15. The method of claim 13, wherein the step of configuring the DRX functionality for the mobile device according to the setting of the mobile device when the setting of the mobile device is changed comprises:
decreasing a time of performing reception functionality of the DRX functionality when the information indicates the mobile device is set to a low power consumption mode; and
increasing the time of performing reception functionality of the DRX functionality when the information indicates the mobile device is set to a high power consumption mode.

16. The method of claim 13, wherein the step of configuring the DRX functionality for the mobile device according to the setting of the mobile device when the setting of the mobile device is changed comprises:
increasing a time of performing reception functionality of the DRX functionality when the setting is the required network response time of the mobile device, and the required network response time is decreased; and
decreasing the time of performing reception functionality of the DRX functionality when the required network response time is increased.

17. The method of claim 13, wherein the step of configuring the DRX functionality for the mobile device according to the setting of the mobile device when the setting of the mobile device is changed comprises:
increasing a time of performing reception functionality of the DRX functionality when the setting is the application mode which is changed from a first application mode to a second application mode, and a power consumption corresponding to the second application mode is greater than a power consumption corresponding to the first application mode; and
decreasing the time of performing reception functionality of the DRX functionality when the application mode is changed from a first application mode to a second application mode, and a power consumption corresponding to the second application mode is less than a power consumption corresponding to the first application mode.

18. The method of claim 13, wherein the step of configuring the DRX functionality for the mobile device according to the setting of the mobile device when the setting of the mobile device is changed comprises:
decreasing a time of performing reception functionality of the DRX functionality when the setting is the application mode which is changed from a first application mode to a second application mode, and a network response time corresponding to the second application mode is greater than a network response time corresponding to the first application mode; and
increasing the time of performing reception functionality of the DRX functionality when the application mode which is changed from a first application mode to a second application mode, and a network response time corresponding to the second application mode is less than a network response time corresponding to the first application mode.

19. The method of claim 12, wherein the step of configuring the DRX functionality for the mobile device according to the setting of the mobile device when the setting of the mobile device is changed comprises:
by mapping or calculation to derive the setting of the DRX functionality according to the information; and
configuring the DRX functionality of the mobile device according to the derived setting of the DRX functionality.

20. A communication system, for managing discontinuous reception (DRX) functionality, comprising:
a mobile device for transmitting information associated to a setting of the mobile device when the setting is changed; and
a network for configuring a DRX functionality for the mobile device according to the information when the information associated to a setting change of the mobile device is received from the mobile device.

21. The communication system of claim 20, wherein the information indicates an application mode, a power consumption or a required network response time of the mobile device.

22. The communication system of claim 21, wherein the application mode is a state of activity of the mobile device, the state of activities comprises a screen on/off, a ring-tone volume on/off, and vibration on/off.

23. The communication system of claim 21, wherein the network is further used for decreasing a time of performing reception functionality of the DRX functionality when the mobile device is set to a low power consumption mode, and increasing the time of performing reception functionality of the DRX functionality when the mobile device is set to a high power consumption mode.

24. The communication system of claim 21, wherein the network is further used for increasing a time of performing reception functionality of the DRX functionality when the information indicates the required network response time of the mobile device is decreased, and decreasing the time of performing reception functionality of the DRX functionality when the information indicates the required network response time is increased.

25. The communication system of claim 21, wherein the network is further used for increasing a time of performing reception functionality of the DRX functionality when the information indicates the mobile device is changed from a first application mode to a second application mode, and a power consumption corresponding to the second application mode is greater than a power consumption corresponding to the first application mode; and decreasing the time of performing reception functionality of the DRX functionality when the information indicates the mobile device is changed from a first application mode to a second application mode, and a power consumption corresponding to the second application mode is less than a power consumption corresponding to the first application mode.

26. The communication system of claim 21, wherein the mobile device is further used for decreasing a time of performing reception functionality of the DRX functionality when the information indicates the mobile device is changed from a first application mode to a second application mode, and a network response time corresponding to the second application mode is greater than a network response time corresponding to the first application mode; and increasing the time of performing reception functionality of the DRX functionality when the information indicates the mobile is changed from a first application mode to a second application mode, and a network response time corresponding to the second application mode is less than a network response time corresponding to the first application mode.

27. The communication system of claim 20, wherein the network derives a setting of the DRX functionality by mapping or calculation; and configures the DRX functionality of the mobile device according to the setting of the DRX functionality.
